(19) United States
(12) Patent Application Publication
(10) Pub. No.: US 2025/0242371 A1
(43) Pub. Date: Jul. 31, 2025

(54) AUTOMATED DISPENSER FOR CLEANING FLUIDS AND THE LIKE

(71) Applicants: Tim CERINI, Ocala, FL (US); Mac FORE, Ocala, FL (US); Merritt FORE, Ocala, FL (US)

(72) Inventors: Tim CERINI, Ocala, FL (US); Mac FORE, Ocala, FL (US); Merritt FORE, Ocala, FL (US)

(21) Appl. No.: 19/040,234

(22) Filed: Jan. 29, 2025

Related U.S. Application Data
(60) Provisional application No. 63/626,258, filed on Jan. 29, 2024.

(51) Int. Cl. B05B 15/14; B05B 15/62; B08B 3/02

(52) U.S. Cl. CPC B05B 15/14; B05B 15/62; B08B 3/02

(57) ABSTRACT

The subject invention pertains to efficient and reliable delivery of needed cleaning fluids from a fixed, known, and well-marked location, through an apparatus that is low maintenance, reliably automated, and self-monitoring. Embodiments employ a method that reduces both effort and uncertainty for both the car wash, service, or cleaning facility operator and the end consumer of the needed cleaning fluids. When the customer pushes a button located in the middle of the housing front door a timer can activate and open a solenoid valve inside the secure housing box to spray window cleaner for the desired duration out of the spray tube nozzle onto the customer's towel.

### CROSS-REFERENCE TO RELATED APPLICATION

The present application claims the benefit of U.S. Provisional Application Ser. No. 63/626,258, filed Jan. 29, 2024, which is hereby incorporated by reference herein in its entirety, including any figures, tables, or drawings.

### BACKGROUND OF THE INVENTION

There exists an ongoing large problem in the car wash and automotive industry related to the need for bottles and nozzles to supply consumers with window cleaner and other cleaning or car care solutions as consumers often steal, break, or misplace these items, resulting in high on going replacement costs to the car wash or car care center operators as well as poor customer service when the bottles are not in place for the next consumer.

### BRIEF SUMMARY OF THE INVENTION

Embodiments of the subject invention provide novel and advantageous systems and methods to autonomously supply cleaning fluids for customers at locations including car washes, gas stations, electric vehicle charging centers, garages, car dealerships, detailing centers, auto parts stores, and any location visited by consumers in need of such fluids. Embodiments deliver fluids in a reliable and economical manner by providing desired fluids in a fixed, non-moving, structurally sound, resilient, and efficient apparatus. Embodiments provide improved customer service and consumer experience at reduced cost by improving uptime, supply, and availability while decreasing setup and maintenance time for facility operators.

### BRIEF DESCRIPTION OF THE DRAWINGS

FIG. 1 illustrates a front outside view of an automated window cleaner apparatus according to an embodiment of the subject invention.

FIG. 2 illustrates a front inside view of an automated window cleaner apparatus according to an embodiment of the subject invention.

FIG. 3 illustrates a bottom outside view of an automated window cleaner apparatus according to an embodiment of the subject invention.

FIG. 4 illustrates a side outside view of an automated window cleaner apparatus according to an embodiment of the subject invention.

FIG. 5 illustrates a top outside view of an automated window cleaner apparatus according to an embodiment of the subject invention.

FIG. 6 illustrates a schematic control circuit diagram of an automated window cleaner apparatus according to an embodiment of the subject invention.

### DETAILED DISCLOSURE OF THE INVENTION

Embodiments of the subject invention provide efficient and reliable delivery of needed cleaning fluids from a fixed, known, and well-marked location, through an apparatus that is low maintenance, reliably automated, and self-monitoring, and using a method that reduces both effort and uncertainty for both the facility operator and the end consumer of the needed cleaning fluids.

Embodiments provide a secure (e.g., 150 mm wide by 170 mm tall by 200 mm deep, 316 stainless steel) enclosure that optionally includes an automated timed control function with a reliable (e.g., stainless steel) adjustable cone to fan nozzle.

Certain embodiments are assembled at a high quality factory using stainless steel fittings and hardware including but not limited to one or more hinges, doors, latches, and locks.

Embodiments optionally provide an adjustable timer (e.g., Automation Direct Part Number: MS45a-ce-adc, Cumming, Georgia) allowing the facility operator to control how much fluid is dispensed per application, and preferably allowing the consumer (e.g., by pressing a control button one or more times, or for a specified length of time) to control how much fluid gets applied to their towel. Embodiments also provide an adjustable spray nozzle to allow a straight cone spray, a fan type spray, or an adjustable pattern between a cone and a fan.

Embodiments advantageously mitigate the need for spray bottles in the car wash industry for self-service vacuum customers. Embodiments replace the spray bottle with a fixed fixture (e.g., a rigidly mounted, sealed, and/or secured, automated or semi-automated system) allowing the consumer to benefit from reliable availability for the window cleaner, as compared to related art hand-held bottles or spray bottles that are easily lost, stolen or broken. Certain embodiments are integrated into a car wash tunnel controller allowing the box only to operate during the operator's desired business hours. Embodiments provide the car wash or other facility operator with consistent products available for their consumer, which can reduce operating costs, increase reliability, and increase consumer satisfaction.

Embodiments solve the need for an operator to monitor, fill, and replace bottles by providing a secure fixture that is permanently mounted, self-refilling, and self-monitoring.

Embodiments solve the problems of spray bottles being stolen, broken, or misplaced by dispensing the product for a consumer (e.g., onto the consumer's provided towel) without the need of a handheld spray bottle, dispenser, or nozzle.

Embodiments provide a fixed dispensing fixture, solving the problem of bottles or dispensers being stolen, broken, misplaced, and/or damaged as the unit is not used by the consumer in a handheld format, but rather, dispenses from a fixed location.

Embodiments solve the problem of wasted product as the unit has the ability to control the amount of fluid output. Embodiments solve the problem of reduced customer service due to unavailable product by providing a larger fluid supply capacity than what is available, practical, or desired in a handheld format.

In one exemplary and non-limiting embodiment, when the consumer pushes the button located in the middle of the box a timer will activate and open a solenoid valve inside the box to spray window cleaner for the desired duration out of the spray tube nozzle onto the consumer's towel. In a preferred embodiment, the timer is not necessary and is omitted in favor of the actuation button simply activating the apparatus for as long as the consumer pushes the button.

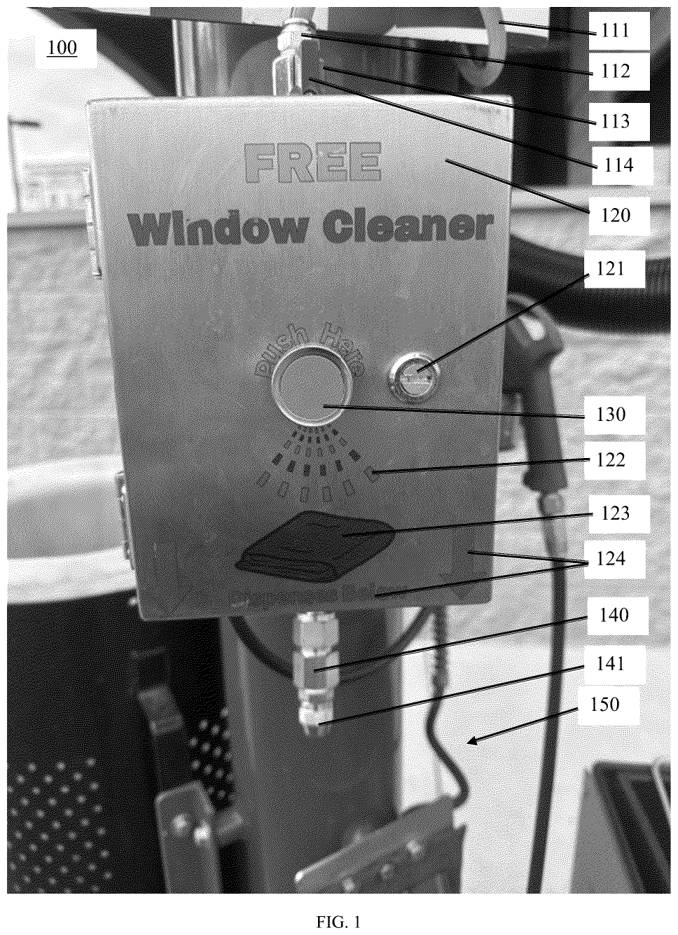

Turning now to the figures, FIG. 1 illustrates a front outside view of an automated window cleaner apparatus according to an embodiment of the subject invention. Automated dispenser external cabinet 100 receives ⅜ polyurethane tube 111 (e.g., 18 inch length) through ⅜″ FPT×⅜″ poly stainless steel fitting 112 and ⅜″ FPT×FPT valve (e.g., PN: VC38) 113 and Valve shutoff lever 114. The front door of Stainless steel Nema 3R box PN 150×170×200 M (316 stainless) 120 covers and secures a lockable interior space (not visible) with Lock 121 and Blue Start button with normally open (NO) contact (e.g., Omron PN: XA2EA31) 130 while displaying to the consumer Decal spray indicator 122, Decal cloth indicator 123 and Decal direction indicator 124. Beneath the box 120, ⅜″ compression×⅜″ FPT stainless steel fitting 140 supports and secures Adjustable cone spray nozzle stainless steel (⅜″ MPT fitting) 141. Power cord 150 provides electrical service to the dispenser.

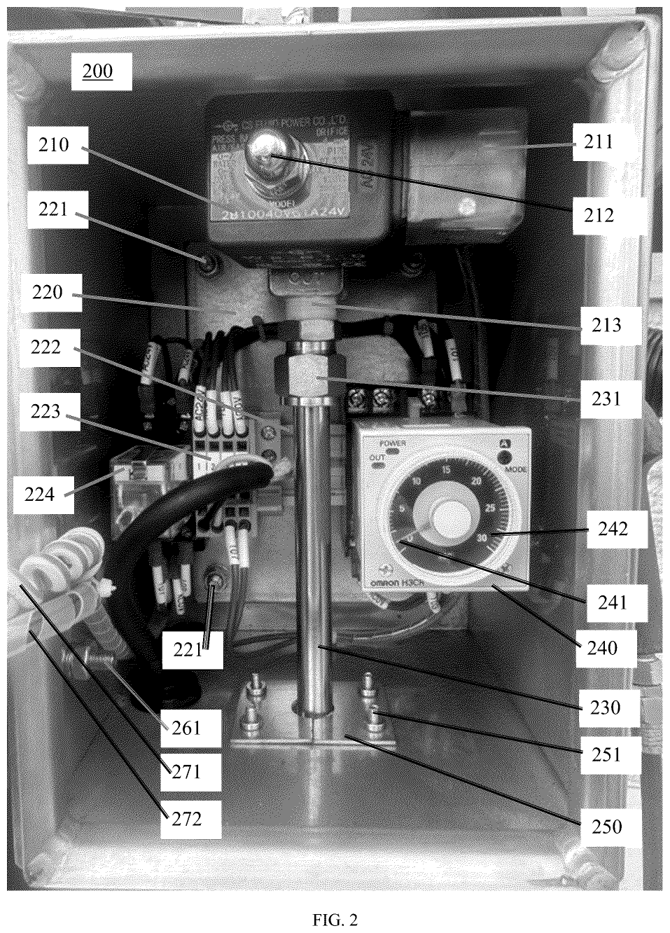

FIG. 2 illustrates a front inside view of a lockable interior space in an automated window cleaner apparatus according to an embodiment of the subject invention. Automated dispenser internal control cabinet 200 contains, secures, and protects the internal components. A ⅜″ FPT normal open valve (e.g. PN: WP-G1-D) 210 mates to DIN connector female end part of valve 211 and is retained by ¼″ cup nut 212. The valve provides fluid flow to ⅜″ MPT×½″ FPT stainless steel fitting 213, and ½″ FPT stainless steel fitting 231, which passes through Secure mounting plate 220, can be provided as either a separate component or a part (e.g., a back panel) of control cabinet 200, and is secured by mounting hardware 221, accessible only from inside the lockable interior space. A 10″ long DIN rail 222 supports 4 terminal block connectors 223, Relay DP 24 VAC coil with base (Omron PN: My2N-GS AC24+P2CF-11) 224, and Time relay DP 24 VAC (Omron PN: H3CR-A AC24-48+P2CF-11) 240 with Pressure indicator 241 and Pressure readout scale 242. Fluid flows through 14″½″ stainless steel tube 230 and ½″ FPT stainless steel fitting 231 through Bottom portal lock ring 250 fastened by Bottom portal lock ring hardware 251, accessible only from within the lockable interior space. Although one side of the hardware can be accessible outside the enclosure, the fact that one portion of a mounting hardware component (e.g., the nuts holding a bolt or screw in place) are restricted from direct outside access can inhibit installation or removal or inhibit tampering with or gaining access to the lockable interior space. Door hinge mounting hardware 261 is accessible from within the lockable interior space and can be seen in front of Coiled cord 271 and Control wiring 272.

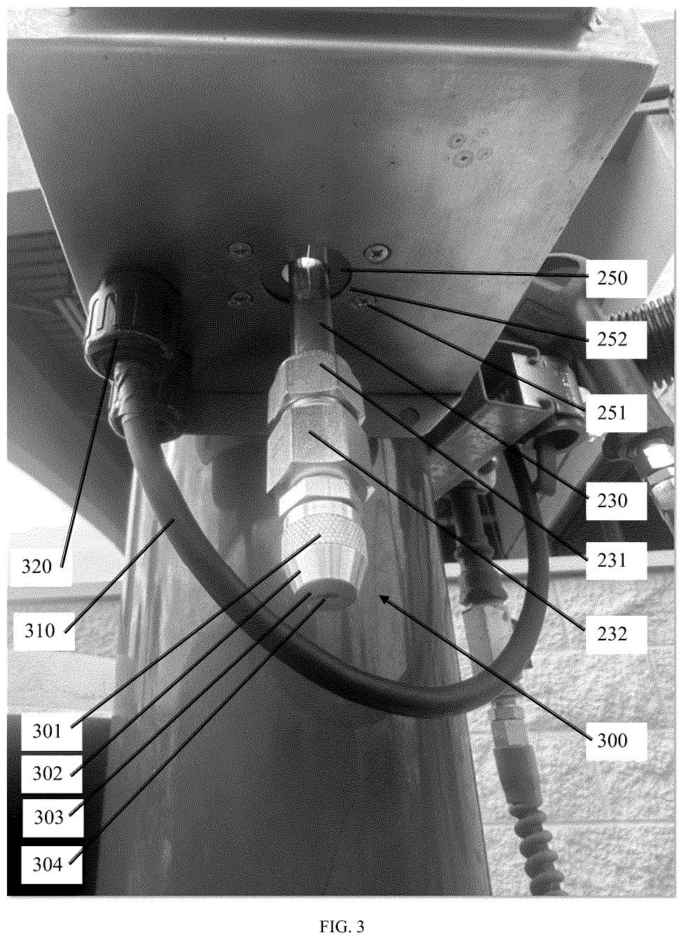

FIG. 3 illustrates a bottom outside view of an automated window cleaner apparatus according to an embodiment of the subject invention. A 14″½″ stainless steel tube 230 connects to ½″ FPT stainless steel fitting 231 and ⅜″ MPT×½″ FPT stainless steel fitting 232 after passing through Bottom portal lock ring 250, which is secured by Bottom portal lock ring hardware 251 at Bottom portal opening 252. Adjustable cone spray nozzle (e.g., stainless steel with ⅜″ MPT fitting) 300 includes Knurled adjuster ring 301, Nozzle body outer taper 302, Nozzle tip face 303, and Adjustable cone spray tip 304. Power cord 310 delivers electric power through Omron ½″ cable gland with lock ring 320.

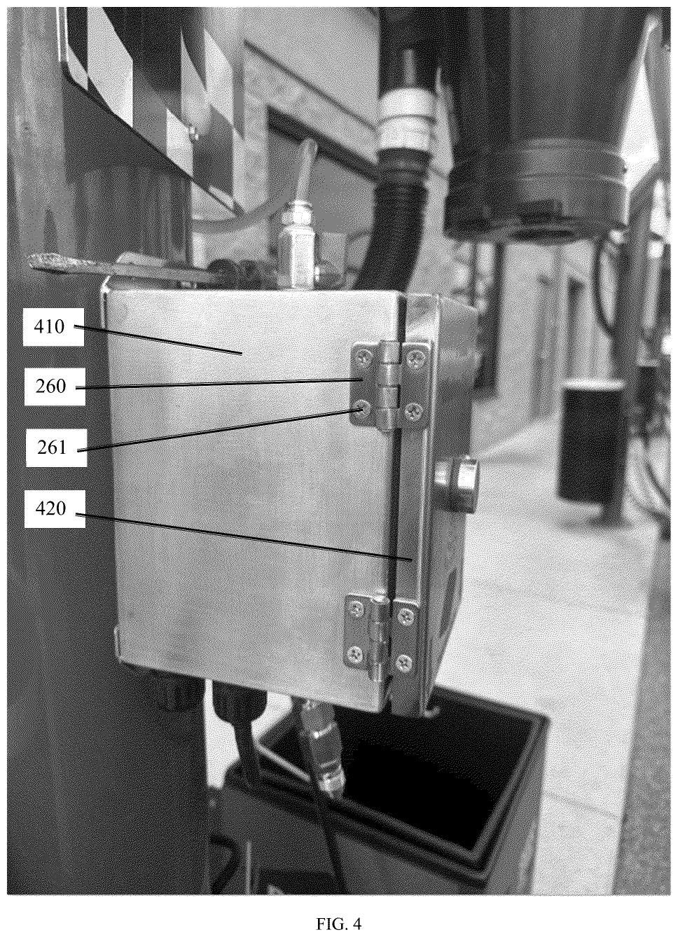

FIG. 4 illustrates a side outside view of an automated window cleaner apparatus according to an embodiment of the subject invention. Stainless steel hinge 260 is fastened by hinge mounting hardware 261 to stainless steel housing body 410 and stainless steel housing door 420.

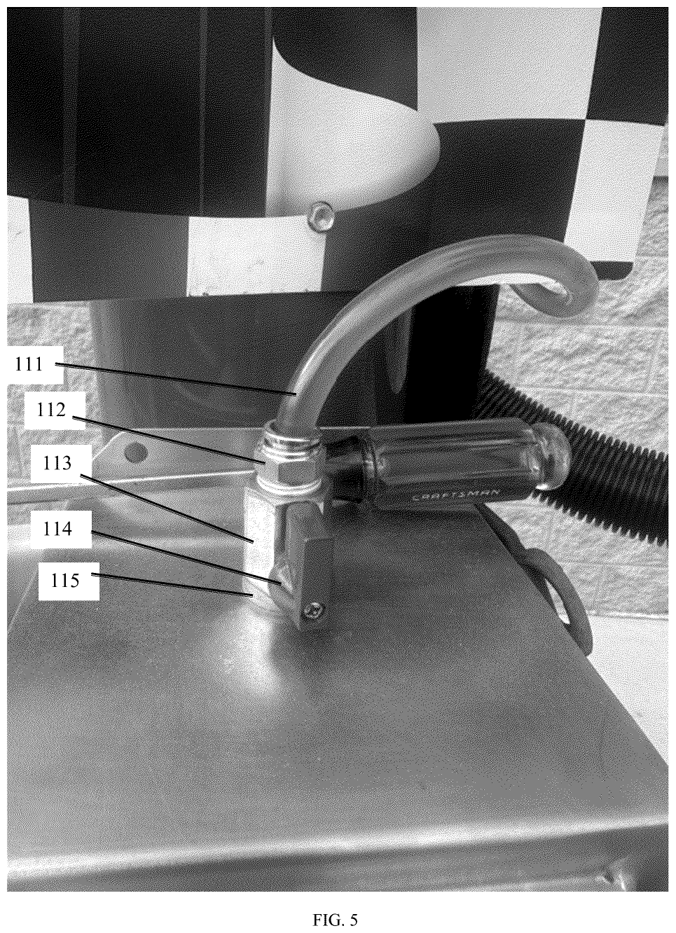

FIG. 5 illustrates a top outside view of an automated window cleaner apparatus according to an embodiment of the subject invention. A ⅜″ clear poly tube 111 connects to ⅜″ FPT×⅜″ poly stainless steel fitting 112 into ⅜″ FPT×FPT valve (e.g., PN: VC38) 113, which is controlled by Valve shutoff lever 114 and sealed against ½″ rubber gasket 115.

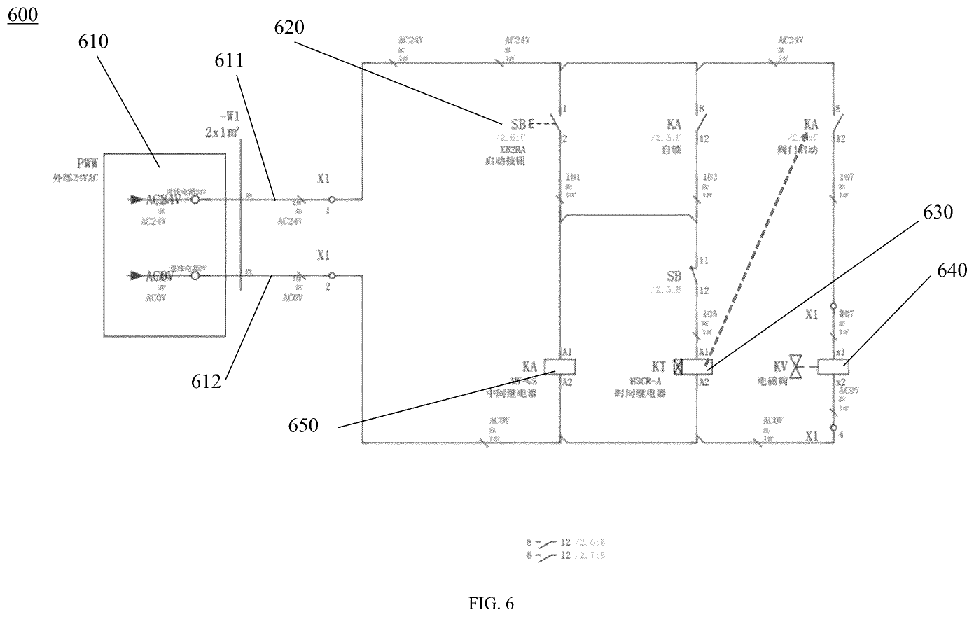

FIG. 6 illustrates a schematic control circuit diagram of an automated window cleaner apparatus according to an embodiment of the subject invention. Schematic 600 includes Omron 24 VAC relay DP (PN: MY2N-GS AC24+P2CF-11) 610 connected through 18 AWG blue wire traces 611, 612 to Omron Blue start button normally open contact (e.g., PN: XA2EA31) 620 and Omron Intermediate timers (e.g., 24 VAC DP PN: MY2N-GS AC24+P2CF-11) 630, 640, and 650.

### Exemplified Embodiments

The invention may be better understood by reference to certain illustrative examples, including but not limited to the following:

Embodiment 1. A tamper resistant system for providing a desired amount of a cleaning fluid on a cleaning cloth for a person within a workspace, the system comprising:
a spray nozzle configured to deliver the cleaning fluid onto the cleaning cloth at a predetermined pressure range and spray pattern;
a fluid valve configured to move between a valve-open configuration and a valve-closed configuration to selectively allow (start) and inhibit (stop) a flow of the fluid to the nozzle;
a controller configured to control the fluid valve to move from the valve-closed configuration to the valve-open configuration and then back to the valve-closed configuration;
a fluid reservoir configured to provide the cleaning fluid to the fluid valve within a specified range of pressure;
an electric power supply configured to provide power to the controller and the fluid valve;
a secure enclosure configured to securely enclose the fluid valve and the controller, to allow entrance of the cleaning fluid from the fluid reservoir to the fluid valve, to allow exit of the cleaning fluid from the fluid valve through the spray nozzle to a spray zone inside the workspace and outside the secure enclosure, and to inhibit ingress of other fluids or tampering with the fluid valve or the controller from outside the secure enclosure.

Embodiment 2. The system according to Embodiment 1, wherein the secure enclosure comprises a body formed primarily from stainless steel, steel, aluminum, or a thermoplastic polymer.

Embodiment 3. The system according to Embodiment 2, wherein the body comprises an access opening covered by a door and secured by a door lock, collectively configured to move from a closed and locked configuration to an open and unlocked configuration.

Embodiment 4. The system according to Embodiment 3, wherein the body comprises a fluid inlet on a top surface thereof and a fluid outlet on a bottom surface thereof.

Embodiment 5. The system according to Embodiment 4, comprising a fluid conduit carrying the cleaning fluid through the fluid inlet and a seal proximal the fluid conduit configured to inhibit ingress of other fluids or tampering with the fluid valve or the controller from outside the secure enclosure through the fluid inlet.

Embodiment 6. The system according to Embodiment 5, wherein the nozzle is located outside the secure enclosure, below the bottom surface of the body.

Embodiment 7. The system according to Embodiment 6, wherein the nozzle is configured to produce a non-vertical spray pattern.

Embodiment 8. The system according to Embodiment 7, wherein the non-vertical spray pattern comprises a fan, a cylindrical cone, or an elliptical cone.

Embodiment 9. The system according to Embodiment 8, wherein the specified range of pressure is 0-7 bar (0-100 psi).

Embodiment 10. The system according to Embodiment 9, wherein the specified range of pressure is 2.75-4.14 bar (40-60 psi).

Embodiment 11. The system according to Embodiment 8, wherein the specified range of pressure is generated by gravity, by a pump, or both.

Embodiment 12. The system according to Embodiment 8, wherein the non-vertical spray pattern comprises a central axis of the spray pattern aligned at an angle between 3°-30° relative to a vertical plane.

Embodiment 13. An automated dispenser apparatus for dispensing cleaning fluids and the like, the apparatus comprising:
a secure housing permanently mounted proximal to a work area;
a reservoir operably configured to deliver a fluid into the housing through a tube routed above the housing;
a fluid dispensing nozzle mounted below the housing;
an input on an exterior face of the housing, operably configured to receive a request for fluid from a person in the work area;
a switch contained within the housing, operably configured to deliver an amount of the fluid from the reservoir to the fluid dispensing nozzle in response to the request for fluid.

Embodiment 14. The apparatus according to Embodiment 13, the secure housing comprising:
a lockable interior space surrounded by a tamper resistant corrosion resistant body comprising at least one material selected from the group consisting of stainless steel, aluminum, and thermoplastic polymers; and
an access door having a lock, the access door and the lock together configured for transformation from a closed and locked configuration to an unlocked and open configuration;
the apparatus comprising a plurality of fasteners operable from within the lockable interior, configured to allow installation or removal of the secure housing only when the door is in an unlocked and open configuration and to inhibit installation or removal of the secure housing when the door is in a closed and locked configuration.

Embodiment 15. The apparatus according to Embodiment 14, the secure housing comprising:
a secure fluid inlet configured to allow the fluid to flow from the reservoir into the lockable interior space while inhibiting other liquids or gasses from entering the lockable interior space proximal the fluid inlet and inhibiting tampering with or gaining access to the lockable interior space proximal the fluid inlet.

Embodiment 16. The apparatus according to Embodiment 15, the dispenser comprising a timer configured to open the switch in response to the request for fluid and then to close the switch following a predetermined time delay.

Embodiment 17. A method for reliably providing a fluid to a consumer at a commercial facility, the method comprising the following steps:
providing a dispenser comprising a lockable interior, a lock, a sealed fluid entry, an electronic controller, a user input, a fluid flow switch, and a fluid spray nozzle;
determining a mounting surface at the commercial facility for the dispenser;
mounting the dispenser to the mounting surface using mounting hardware secured from within the lockable interior;
connecting a fluid supply to the sealed fluid entry;
activating the user input;
dispensing a predetermined amount of the fluid through the fluid spray nozzle; and
securing the lock;
   wherein the lock is configured to inhibit access to the lockable interior when secured;
   wherein the fluid spray nozzle is fluidly connected to a fluid output of the fluid flow switch;
   wherein the user input is configured to produce a signal when activated;
   wherein the electronic controller is located within the lockable interior and is configured to activate the fluid flow switch in response to the signal from the user input and then deactivate the fluid flow switch;
   wherein the sealed fluid entry is fluidly connected to an input of the fluid flow switch;
   wherein the fluid flow switch is configured to allow a flow of the fluid within the lockable interior from the sealed fluid entry to the fluid spray nozzle upon activation of the fluid flow switch and to inhibit the flow of the fluid within the lockable interior from the sealed fluid entry to the fluid spray nozzle upon deactivation of the fluid flow switch;
   wherein the sealed fluid entry is configured to allow entry of the fluid into the lockable interior while inhibiting entry of other substances into the lockable interior;
   wherein the mounting hardware secured from within the lockable interior is configured to inhibit tampering with or removal of the dispenser when the lock is secured;
   wherein the mounting surface is determined to provide a desired access for the consumer at an advantageous location at the commercial facility.

Embodiment 18. The method according to Embodiment 17, the spray nozzle configured to produce a fluid spray pattern below the dispenser, the spray pattern oriented downward and in a direction substantially at an angle between 3°-30° relative to a vertical plane

Embodiment 19. The method according to Embodiment 18, further comprising a step of setting the desired time duration in the electronic controller, which comprises setting a value in a separate controller or computer outside the lockable interior and transmitting the value to the electronic controller within the lockable interior.

Embodiment 20. The method according to Embodiment 19, comprising the steps of:
providing a multiplicity of dispensers, each respectively comprising a lockable interior, a lock, a sealed fluid entry, an electronic controller, a user input, a fluid flow switch, and a fluid spray nozzle;
determining a multiplicity of mounting surfaces at the commercial facility for each respective dispenser;
mounting each respective dispenser to a respective mounting surface using mounting hardware secured from within the respective lockable interior;
connecting a fluid supply to each respective sealed fluid entry;
setting a desired time duration in each respective electronic controller;
activating each respective user input;
dispensing a predetermined amount of the fluid through each respective fluid spray nozzle; and
securing each respective lock;
   wherein the fluid supply comprises a pumping station and a multiplicity of tubes configured to provide the fluid to each respective dispenser in the multiplicity of dispensers.

### Materials and Methods

All patents, patent applications, provisional applications, and publications referred to or cited herein are incorporated by reference in their entirety, including all figures and tables, to the extent they are not inconsistent with the explicit teachings of this specification.

Following are examples that illustrate procedures for practicing the invention. These examples should not be construed as limiting. All percentages are by weight and all solvent mixture proportions are by volume unless otherwise noted.

### EXAMPLE 1—Detailed Description of Components According to an Embodiment of the Subject Invention.

TABLE 1
Selected parts and components bill of materials for proof of concept prototype.

| Product | QTY | Vendor | City, State | Part Number |
|---|---|---|---|---|
| Stainless Steel Enclosure | 1 | Automation | Cumming, GA | EJ866SS |
| | | Direct | | |
| Blue Button | 1 | Automation | Cumming, GA | EDT. VBL |
| | | Direct | | |
| NO Closed Contact | 1 | Automation | Cumming, GA | EF03.1 |
| | | Direct | | |
| ½″ Cord Grips | 2 | Automation | Cumming, GA | BSPBX-22-W |
| | | Direct | | |
| ⅜″ x ⅜″ MPT Poly | 2 | Automation | Cumming, GA | BSPAX-21-W |
| Fitting | | Direct | | |
| ⅜″ Bulk Head Fitting | 1 | Automation | Cumming, GA | MS38-38N |
| | | Direct | | |
| Single Function | 1 | Grainger | Lake Forest, IL | 21EW93 |
| Encapsulated Timing | | | | |
| Relay (optional) | | | | |
| Sticker for Front of Box | 1 | Loco Graphics | Ocala, FL | Ref. Inv 3524 |
| ½″ SS Tube x ¼″ | 1 | Mako | Edmond, OK | SFCI-8-4N |
| Fitting | | | | |
| ⅜″ MPT x ½″ SS | 3 | Mako | Edmond, OK | SMCI-8-6N |
| Compression Fitting | | | | |
| ½″ SS Tube x ½″ | 1 | Mako | Edmond, OK | SFCI-8-8N |
| Fitting | | | | |
| ⅜″ NC 24VAC Valve | 1 | Sonny's | Tamarac, FL | 10006093 |
| DIN | | | | |
| Full Cone Nozzle (white) | 1 | Sonny's | Tamarac, FL | 10002044 |
| Square style DIN Plug | 1 | Sonny's | Tamarac, FL | 10011685 |
| Connector | | | | |
| ⅝″ x 1 ¼″ SS Washer | 4 | Southern Blade | Ocala, FL | Pick up |
| | | & Supply | | |

FIG. 1:
100: Automated dispenser external cabinet
111: ⅜ polyurethane tube (18 inch length)
112: ⅜″ FPT×⅜″ poly stainless steel fitting
113: ⅜″ FPT×FPT valve PN: VC38
114: Valve shutoff lever
120: Stainless steel Nema 3R box PN 150×170×200 M (316 stainless)
121: Lock
130: Blue Start button with normally open (NO) contact. PN: XA2EA31 Brand: Omron
122: Decal spray indicator
123: Decal cloth indicator
124: Decal direction indicator
140: ⅜″ compression×⅜″ FPT stainless steel fitting
141: Adjustable cone spray nozzle stainless steel (⅜″ MPT fitting)
150: Power cord

FIG. 2:
200: Automated dispenser internal control cabinet
210: ⅜″ FPT normal open valve. PN: WP-G1-D
211: DIN connector female end part of valve
212: ¼″ cup nut part of valve
213: ⅜″ MPT×½″ FPT stainless steel fitting
231: ⅜″ mounting hardware
220: Secure mounting plate
221: Mounting hardware
222: 10″ long DIN rail
223: 4 terminal block connectors
224: Relay DP 24 VAC coil with base, Omron PN: My2N-GS AC24+P2CF-11
230: 14″½″ stainless steel tube
231: ½″ FPT stainless steel fitting
240: Time relay DP 24 VAC Brand: Omron PN: H3CR-A AC24-48+P2CF-11
241: Pressure indicator
242: Pressure readout scale
250: Bottom portal lock ring
251: Bottom portal lock ring hardware
261: Door hinge mounting hardware
271: Coiled cord
272: Control wiring

FIG. 3:
230: 14″½″ stainless steel tube
231: ½″ FPT stainless steel fitting
232: ⅜″ MPT×½″ FPT stainless steel fitting
250: Bottom portal lock ring
251: Bottom portal lock ring hardware
252: Bottom portal opening
300: Adjustable cone spray nozzle stainless steel. ⅜″ MPT fitting
301: Knurled adjuster ring
302: Nozzle body outer taper
303: Nozzle tip face
304: Adjustable cone spray tip
310: Power cord
320: ½″ cable gland with lock ring, Brand: Omron

FIG. 4:
260: stainless steel hinge
261: hinge mounting hardware
410: stainless steel housing body
420: stainless steel housing door

FIG. 5:
111: ⅜″ clear poly tube
112: ⅜″ FPT×⅜″ poly stainless steel fitting
113: ⅜″ FPT×FPT valve PN: VC38
114: Valve shutoff lever
115: ½″ rubber gasket

FIG. 6:
600: Schematic
610: 24 VAC relay DP PN: MY2N-GS AC24+P2CF-11, Omron
611: 18 AWG blue wire
612: 18 AWG blue wire
620: Blue start button normally open contact PN: XA2EA31, Omron
630,640,650 Intermediate timer 24 VAC DP PN: MY2N-GS AC24+P2CF-11, Omron

### EXAMPLE 2—Instructions for Installation, Preparation, and Consumer Use According to an Embodiment of the Subject Invention

Embodiments can be installed either outside or inside of a car wash, cleaning, service or other facility, and for example, can be mounted on a pole or a flat surface using operator supplied hardware. Typical mounting can occur on an operator supplied vacuum post or close to where consumers prefer to vacuum or clean their vehicles. Step by step install by a facility operator, according to an embodiment of the subject invention can comprise the following steps.

Step 1: Determine a mounting location where the operator would like the dispenser to be mounted to provide easy access for the consumer. By way of example and not limitation, the mounting location can be within 8′ of a consumer vacuum parking spot.

Step 2: Mount the dispenser to the desired surface using operator supplied hardware, by way of example but not limitation, Tapcons for concrete or self-drilling screws for metal.

Step 3: Have a qualified electrician run an approved power and control conduit (e.g., a three conductor 18 AWG SO cord or stranded wire) from facility tunnel controller to the dispenser. The black wire can be terminated on any open 24 VAC normally open relay. Timing can be selected by the operator within their tunnel controller system. White wire can be terminated on the neutral terminal for 24 VAC OV. Green wire can be terminated to earth ground. Black wire inside of the dispenser can be terminated to a terminal block (e.g., labeled AV24V) and the white wire can be terminated on a terminal block (e.g., labeled ACOV.) Green wire can be terminated on ground (e.g., labeled G) on the terminal block. All dispenser boxes can be wired in series starting with any box.

Step 4: Operator installation technician to run ⅜″ clear poly tube from operator supplied pumping station (e.g., hydrominder or similar, PSG, Cincinnati, OH) to the first dispenser. Poly tube to be run to the first box and then ⅜″ stainless steel poly tube tee to be installed at top of each box allowing one trunk line to feed each box. The clear tube can be installed into the valve located on top of the box.

Step 5: Operator installation technician to turn on or time-automate the tunnel controller relay allowing 24 VAC to be provided to the dispenser.

Step 6: Operator installation technician to turn on pumping station (e.g., hydrominder) and set it to 60 PSI. One hydrominder can provide fluid to up to 8 dispensers.

Step 7: Operator installation technician to turn the valve on top of the dispenser housing box to an open (e.g., vertical) position.

Step 8: Operator installation technician to press the control button on the center of the box and verify operation. Operator installation technician can then optionally set desired application time.

Step 9: You are done and ready to provide a great product to your customer.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A tamper resistant system for providing a desired amount of a cleaning fluid on a cleaning cloth for a person within a workspace, the system comprising:
a spray nozzle configured to deliver the cleaning fluid onto the cleaning cloth at a predetermined pressure range and spray pattern;
a fluid valve configured to move between a valve-open configuration and a valve-closed configuration to selectively start and stop a flow of the fluid to the nozzle;
a controller configured to control the fluid valve to move from the valve-closed configuration to the valve-open configuration and then back to the valve-closed configuration;
a fluid reservoir configured to provide the cleaning fluid to the fluid valve within a specified range of pressure;
an electric power supply configured to provide power to the controller and the fluid valve;
a secure enclosure configured to securely enclose the fluid valve and the controller, to allow entrance of the cleaning fluid from the fluid reservoir to the fluid valve, to allow exit of the cleaning fluid from the fluid valve through the spray nozzle to a spray zone inside the workspace and outside the secure enclosure, and to inhibit ingress of other fluids or tampering with the fluid valve or the controller from outside the secure enclosure.

2. The system according to claim 1, wherein the secure enclosure comprises a body formed primarily from stainless steel, steel, aluminum, or a thermoplastic polymer.

3. The system according to claim 2, wherein the body comprises an access opening covered by a door and secured by a door lock, collectively configured to move from a closed and locked configuration to an open and unlocked configuration.

4. The system according to claim 3, wherein the body comprises a fluid inlet on a top surface thereof and a fluid outlet on a bottom surface thereof.

5. The system according to claim 4, comprising a fluid conduit carrying the cleaning fluid through the fluid inlet and a seal proximal the fluid conduit configured to inhibit ingress of other fluids or tampering with the fluid valve or the controller from outside the secure enclosure through the fluid inlet.

6. The system according to claim 5, wherein the nozzle is located outside the secure enclosure, below the bottom surface of the body.

7. The system according to claim 6, wherein the nozzle is configured to produce a non-vertical spray pattern.

8. The system according to claim 7, wherein the non-vertical spray pattern comprises a fan, a cylindrical cone, or an elliptical cone.

9. The system according to claim 8, wherein the specified range of pressure is 0-7 bar (0-100 psi).

10. The system according to claim 7, wherein the specified range of pressure is 2.75-4.14 bar (40-60 psi).

11. The system according to claim 8, wherein the specified range of pressure is generated by gravity, by a pump, or both.

12. The system according to claim 8, wherein the non-vertical spray pattern comprises a central axis of the spray pattern aligned at an angle between 3°-30° relative to a vertical plane.

13. An automated dispenser apparatus for dispensing cleaning fluids and the like, the apparatus comprising:
a secure housing permanently mounted proximal to a work area;
a reservoir operably configured to deliver a fluid into the housing through a tube routed above the housing;
a fluid dispensing nozzle mounted below the housing;
an input on an exterior face of the housing, operably configured to receive a request for fluid from a person in the work area;
a switch contained within the housing, operably configured to deliver an amount of the fluid from the reservoir to the fluid dispensing nozzle in response to the request for fluid.

14. The apparatus according to claim 13, the secure housing comprising:
a lockable interior space surrounded by a tamper resistant corrosion resistant body comprising at least one material selected from the group consisting of stainless steel, aluminum, and thermoplastic polymers; and
an access door having a lock, the access door and the lock together configured for transformation from a closed and locked configuration to an unlocked and open configuration;
the apparatus comprising a plurality of fasteners operable from within the lockable interior, configured to allow installation or removal of the secure housing only when the door is in an unlocked and open configuration and to inhibit installation or removal of the secure housing when the door is in a closed and locked configuration.

15. The apparatus according to claim 14, the secure housing comprising:
a secure fluid inlet configured to allow the fluid to flow from the reservoir into the lockable interior space while inhibiting other liquids or gasses from entering the lockable interior space proximal the fluid inlet and inhibiting tampering with or gaining access to the lockable interior space proximal the fluid inlet.

16. The apparatus according to claim 15, the dispenser comprising a timer configured to open the switch in response to the request for fluid and then to close the switch following a predetermined time delay.

17. A method for reliably providing a fluid to a consumer at a commercial facility, the method comprising the following steps:
providing a dispenser comprising a lockable interior, a lock, a sealed fluid entry, an electronic controller, a user input, a fluid flow switch, and a fluid spray nozzle;
determining a mounting surface at the commercial facility for the dispenser;
mounting the dispenser to the mounting surface using mounting hardware secured from within the lockable interior;
connecting a fluid supply to the sealed fluid entry;
activating the user input;
dispensing a predetermined amount of the fluid through the fluid spray nozzle; and
securing the lock;
wherein the lock is configured to inhibit access to the lockable interior when secured;
wherein the fluid spray nozzle is fluidly connected to a fluid output of the fluid flow switch;
wherein the user input is configured to produce a signal when activated;
wherein the electronic controller is located within the lockable interior and is configured to activate the fluid flow switch in response to the signal from the user input and then deactivate the fluid flow switch;
wherein the sealed fluid entry is fluidly connected to an input of the fluid flow switch;
wherein the fluid flow switch is configured to allow a flow of the fluid within the lockable interior from the sealed fluid entry to the fluid spray nozzle upon activation of the fluid flow switch and to inhibit the flow of the fluid within the lockable interior from the sealed fluid entry to the fluid spray nozzle upon deactivation of the fluid flow switch;
wherein the sealed fluid entry is configured to allow entry of the fluid into the lockable interior while inhibiting entry of other substances into the lockable interior;
wherein the mounting hardware secured from within the lockable interior is configured to inhibit tampering with or removal of the dispenser when the lock is secured;
wherein the mounting surface is determined to provide a desired access for the consumer at an advantageous location at the commercial facility.

18. The method according to claim 17, the spray nozzle configured to produce a fluid spray pattern below the dispenser, the spray pattern oriented downward and in a direction substantially at an angle between 3°-30° relative to a vertical plane.

19. The method according to claim 18, further comprising a step of setting the desired time duration in the electronic controller, which comprises setting a value in a separate controller or computer outside the lockable interior and transmitting the value to the electronic controller within the lockable interior.

20. The method according to claim 19, comprising the steps of:
providing a multiplicity of dispensers, each respectively comprising a lockable interior, a lock, a sealed fluid entry, an electronic controller, a user input, a fluid flow switch, and a fluid spray nozzle;
determining a multiplicity of mounting surfaces at the commercial facility for each respective dispenser;
mounting each respective dispenser to a respective mounting surface using mounting hardware secured from within the respective lockable interior;
connecting a fluid supply to each respective sealed fluid entry;
setting a desired time duration in each respective electronic controller;
activating each respective user input;
dispensing a predetermined amount of the fluid through each respective fluid spray nozzle; and
securing each respective lock;
wherein the fluid supply comprises a pumping station and a multiplicity of tubes configured to provide the fluid to each respective dispenser in the multiplicity of dispensers.
